(19) United States
(12) Patent Application Publication
(10) Pub. No.: US 2023/0167562 A1
(43) Pub. Date: Jun. 1, 2023

(54) CARBON-ASSISTED SOLID OXIDE ELECTROLYSIS CELL

(71) Applicant: ZHEJIANG UNIVERSITY, Hangzhou (CN)

(72) Inventors: Haoran Xu, Hangzhou (CN); Yu Han, Hangzhou (CN); Gang Xiao, Hangzhou (CN); Anwei Sun, Hangzhou (CN); Wei Shuai, Hangzhou (CN)

(21) Appl. No.: 18/071,068

(22) Filed: Nov. 29, 2022

(30) Foreign Application Priority Data
Dec. 1, 2021 (CN) 202111453775.0

(51) Int. Cl. C25B 9/015; C25B 1/23; C25B 1/042; C25B 9/19; C25B 11/031; C25B 11/093; C25B 13/07

(52) U.S. Cl. CPC C25B 9/015; C25B 1/23; C25B 1/042; C25B 9/19; C25B 11/031; C25B 11/093; C25B 13/07

(57) ABSTRACT

The present invention relates to a carbon-assisted solid oxide electrolysis cell comprising: a cathode, an electrolyte, an anode, and an anode chamber set in the order. The cathode is supplied with water as an oxidant and the reduction reaction occurs. The anode chamber includes carbon fuel and CO₂ absorber, supplied with the water as in situ gasification agent, wherein the water assists the gasification of the carbon fuel to generate CO and H₂. The O²⁻ ions generated by cathode are transported to the anode through the electrolyte, and react with CO and H₂ generated in the anode chamber as oxidant. The CO produced by the carbon gasification reaction partly reacts with water to generate CO₂ and H₂, while the CO₂ absorber promotes the production of H₂ by absorbing the CO₂ produced by the water gas shift reaction. The present invention can control the internal gas composition of the CA-SOEC anode effectively, improving the performance of the carbon-assisted electrolysis cell and reducing energy consumption. Furthermore, the present invention achieves the simultaneous generation of fuel gas by the cathode and the anode, significantly improving the efficiency of the electrolysis.

### CROSS REFERENCE TO RELATED APPLICATION

This application claims the priority of Chinese Patent Application No. 2021114537750, entitled “Carbon-assisted Solid Oxide Electrolysis Cell”, filed on Dec. 1, 2021, the disclosure of which is incorporated herein by reference in its entirety.

### BACKGROUND

### 1. Field of the Invention

The present invention relates to the field of electrolysis, and more particularly to carbon-assisted solid oxide electrolysis cell.

### 2. Description of Related Art

There is an urgent need for technological upgrading on the energy supply and consumption side to develop economy while protecting environment and utilizing resource effectively for the goals of “Carbon Neutral Society”. Electrolysis, as an advanced energy conversion device, can convert excess unstable electricity from renewable energy into fuels for storage through electrolysis reaction, which has the advantages of no pollution, low reactant cost and high efficiency. Electrolysis is expected to play an important role in various power supply/consumption scenarios such as power stations and transportation.

Compared with low-temperature electrolysis cells, solid oxide electrolysis cells (SOECs) have the irreplaceable advantages of lower power demand, excellent reaction kinetics, and no noble metal catalysts.

Based on SOEC, the carbon-assisted solid oxide electrolysis cell (CA-SOEC) using solid carbon fuel for auxiliary electrolysis can significantly decrease the operating potential and reduce power consumption by replacing the anode oxygen evolution reaction (OER). Thus, CA-SOEC is an advanced energy device with great development potential and market prospects. At present, there are many challenges that exist in the commercial application of CA-SOEC, such as slow carbon oxidation rate, low current density at small operating potential, and slow oxygen evolution kinetics.

### SUMMARY OF THE INVENTION

To solve problems in the prior art, the present invention develops a CA-SOEC to improve the reaction rate of carbon gasification by supplying water as in situ gasification agent. Particularly, by adding CO₂ absorber to the anode chamber, CO₂ generated by the electrochemical oxidation of CO is rapidly absorbed. In this way, steam-carbon gasification can dominate the carbon gasification process and Boudouard reaction is suppressed. Such method not only increases the carbon gasification rate, but also generates more H₂ as the fuel, which provides higher electrochemical kinetic and faster transportation speed compared with CO. It also helps matching the reaction rate between carbon gasification and electrochemical oxidation in the CA-SOEC and leads to the effective control of the gas composition in the anode. The performance of the carbon-assisted solid oxide electrolysis cell can thus be improved and the energy consumption can be reduced. Besides, gaseous fuels can be generated at both cathode and anode, which further improves the economic feasibility of the SOEC.

The present invention relates to a carbon-assisted solid oxide electrolysis cell comprising: a cathode, an electrolyte, an anode, and an anode chamber set in the order. The cathode is supplied with water as an oxidant and the reduction reaction occurs. The anode chamber includes carbon fuel and CO₂ absorber, supplied with the water as in situ gasification agent, wherein the water assists the gasification of the carbon fuel to generate CO and H₂. The O²⁻ ions generated by cathode are transported to the anode through the electrolyte, and react with CO and H₂ generated in the anode chamber as oxidant. The CO produced by the carbon gasification reaction partly reacts with water to generate CO₂ and H₂, while the CO₂ absorber promotes the production of H₂ by absorbing the CO₂ produced by the water gas shift reaction.

The present invention can control the internal gas composition of the CA-SOEC anode effectively, improving the performance of the carbon-assisted electrolysis cell and reducing energy consumption. Furthermore, the invention achieves the simultaneous generation of fuel gas by the cathode and the anode, significantly improving the efficiency of the electrolysis.

In the present invention, anode chamber supplied with water as gasification agent to increase the carbon gasification reaction rate, mass transfer rate and electrochemical activity, while significantly reduce the performance degradation of the electrolysis caused by concentration polarization and activation polarization, thereby greatly reducing the operating potential and reducing energy consumption. The adoption of CO₂ absorber to decrease CO₂ content can further promote the carbon gasification reaction of water, producing more H₂, and thus improve the performance of CA-SOEC.

Preferably, the carbon-assisted solid oxide electrolysis cell operates in the temperature range of 650 to 850° C.

Based on this scheme, it is conducive to reducing the material and preparation costs of CA-SOEC and improving the long-term operation stability of CA-SOEC in the temperature range.

Preferably, the CO₂ absorber is CaO.

Based on this scheme, the Gibbs free energy for H₂O absorption by CaO is positive, while the Gibbs free energy for CO₂ absorption is negative in the temperature range. When Gibbs free energy is negative, the absorption reaction of CaO for CO₂ happens spontaneously, without H₂O absorption, which can produce more fuel gas H₂ required for the electrolysis. Besides, the H₂ diffusion rate is faster and the electrochemical activity is higher, which is conducive to improving the output performance of CA-SOEC.

Preferably, the cathode and anode flowrates of water are both 50-500 mL/min.

Based on this scheme, the operating temperature in CA-SOEC is stable, and the output performance of CA-SOEC is stable, with the range of water flowrate.

Preferably, CA-SOEC has a tubular structure with the length of 9 cm, inner diameter of 11.5 mm, and outer diameter of 12.0 mm. The thicknesses of cathode, anode, and electrolyte are 20 μm, 20 μm, and 20 μm, respectively. The operating voltage of the tubular electrolysis is 1˜−0.1V. Compared with the prior art, the operating voltage of solid oxide electrolysis cell with same size is 1.4V. CA-SOEC of the present invention can realize low-voltage electrolysis of water, and even negative voltage hydrogen production. The performance of present invention is better than the existing CA-SOEC, and can achieve fuel-electricity coproduction.

Preferably, the anode chamber discharges a mixture of gas comprising H₂, CO, and H₂O.

Based on this scheme, the mixed gas produced by the anode chamber can be used as a raw material for the synthesis of high value-added methanol and other hydrocarbon fuels, basically meeting the carbon-free system and satisfying higher energy utilization conversion efficiency.

Preferably, the anode chamber also includes carbonate catalyst.

Based on this scheme, the carbonate catalyst can promote the main reaction, changing the reaction path and reducing the reaction energy barrier, and thus ensures the stable output performance of the electrolysis with the increase anode flowrate. Compared with noble metal catalysts, carbonate catalysts also have the advantages of low price and ease of acquisition.

Preferably, the carbon fuel is inorganic including coal, coke, active carbon, graphite, fibreboard, black carbon, and biochar.

Based on this scheme, carbon fuel from a variety of sources is conducive to reducing the manufacturing cost and is suitable for large-scale application of CA-SOEC.

Preferably, the anode and cathode materials are both Ag-GDC, and the electrolyte material is YSZ. The cathode and anode materials are porous enough for gas transport, and the electrolyte material is dense enough to separate the gases produced by the anode and cathode.

Based on this scheme, CO produced by carbon gasification is oxidized in the anode of CA-SOEC. To avoid carbon deposits from damaging the activity of anode catalysts such as Ni, metal silver is used as the electrode material to avoid the deposition of carbon on the electrode, which affects the output performance of CA-SOEC. Cathode, anode and electrolyte materials are easily acquired, which helps to reduce the manufacturing cost of CA-SOEC.

### BRIEF DESCRIPTION OF THE DRAWINGS

FIG. 1 is a schematic diagram of the reaction distribution in carbon-assisted solid oxide electrolysis cell according to the present invention;

FIG. 2 is a schematic structural diagram of the carbon-assisted solid oxide electrolysis cell according to the present invention.

### DESCRIPTION OF THE REFERENCE NUMERALS

Cathode 1; electrolyte 2; anode 3; anode chamber 4; anode inlet pore 41; water supply unit 411; first circulating pump 412; anode outlet pore 42; anode end gas storage tank 421; absorber outlet 43; anode chamber waste storage tank 431; anode chamber filling port 44; mixer 441; absorber supply unit 442; solid carbon supply unit 443; cathode chamber 5; cathode inlet pore 51; oxidizing agent supply unit 511; second circulating pump 512; cathode outlet pore 52; cathode end gas storage tank 521.

### DETAILED DESCRIPTION OF THE PREFERRED EMBODIMENTS

The following technical solution in the embodiment of the present invention is clearly and completely described with the accompanying drawings. Obviously, the embodiments described are only a partial embodiment of the present invention, not all embodiments. Based on embodiments of the present invention, all other embodiments obtained by those of ordinary skill in the art without performing inventive work fall within the scope of protection of the present invention.

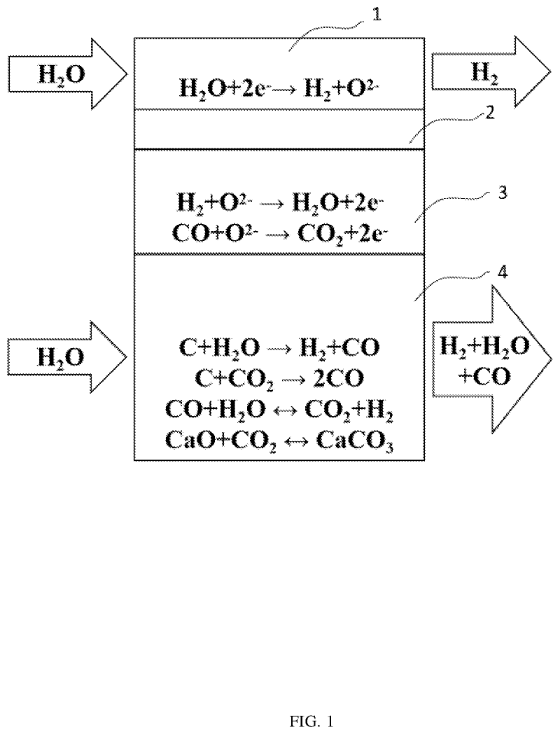

As shown in FIG. 1, the present invention develops a carbon-assisted solid oxide electrolysis cell with in situ CO₂ absorption comprising: cathode 1, electrolyte 2, anode 3, and anode chamber 4. The cathode 1 is supplied with water as an oxidant to generate H₂ and O²⁻ by reduction reaction. The anode chamber 4 includes carbon fuel and CO₂ absorber, supplied with the water as in situ gasification agent, wherein the water assists the gasification of the carbon fuel to generate CO and H₂. The O²⁻ ions generated by cathode 1 are transported to the anode 3 through the electrolyte 2, and react with CO and H₂ generated in the anode chamber 4 as oxidant. The CO produced by the carbon gasification reaction partly reacts with water to generate CO₂ and H₂, while the CO₂ absorber promotes the production of H₂ by absorbing the CO₂ produced by the water gas shift reaction.

In the present invention, anode chamber 4 supplied with water as gasification agent to increase the carbon gasification reaction rate, mass transfer rate and electrochemical activity, while significantly reduce the performance degradation of the electrolysis caused by concentration polarization and activation polarization, thereby greatly reducing the operating potential and reducing energy consumption. The adoption of CO₂ absorber to decrease CO₂ content can further promote the carbon gasification reaction of water, producing more H₂. According to the above, the present invention can increase the proportion of H₂O (H₂) to CO₂ (CO) components, further reduce the operating voltage of CA-SOEC, and thus improve the performance of CA-SOEC. The embodiment of the present invention is based on the equilibrium mechanism of carbon gasification-electrochemical oxidation process in the anode chamber 4, which CA-SOEC can avoid safety problems such as excessive internal pressure caused by exhaust gas accumulation, and finally develop it into a potential refillable charge-discharge electrolysis with high bulk energy density. On the other hand, embodiments of the present invention can reduce the operating temperature of CA-SOEC, thereby helping to reduce the material and preparation costs of CA-SOEC, and improve the long-term operation stability of CA-SOEC.

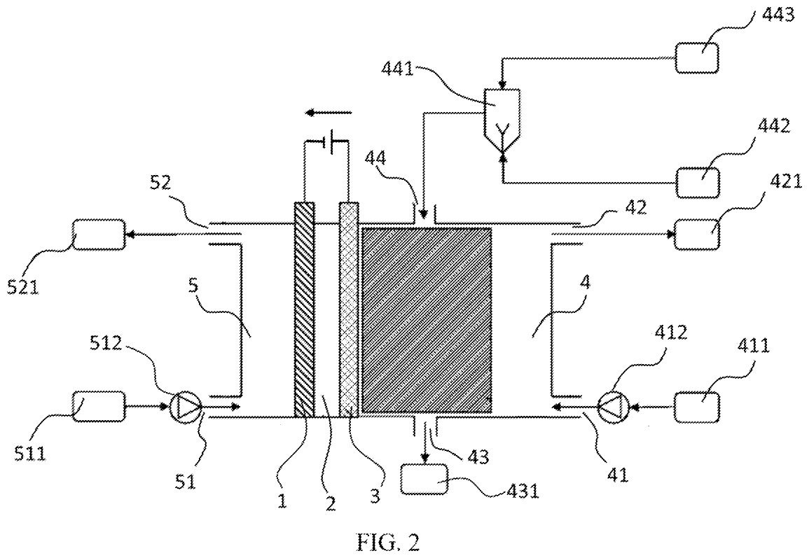

Specifically, as shown in FIG. 2, the carbon-assisted solid oxide electrolysis cell in the present invention comprise anode chamber 4 including anode inlet pore 41 and anode outlet pore 42. Water is provided by a water supply unit 411, and the water supply unit 411 is connected to the anode inlet pore 41 through the first circulating pump 412. The anode outlet port 42 is connected to the anode end gas storage tank 421. The anode chamber 4 further comprises an absorber outlet 43 and an anode chamber filling port 44, while the absorber outlet 43 is connected to the anode chamber waste storage tank 431. The anode chamber filling port 44 is connected to the outlet of the mixer 441, and the mixer 441 receives the absorber and solid carbon fuel. The absorber is provided through the absorber supply unit 442, while the carbon fuel is provided through the solid carbon supply unit 443. The outlet of the absorber supply unit 442 and the outlet of the solid carbon supply unit 443 are connected to the inlet of the mixer 441, respectively.

The cathode chamber 5 includes cathode inlet pore 51 and cathode outlet pore 52. Water as an oxidizing agent is provided by the oxidizing agent supply unit 511. The oxidizing agent supply unit 511 is connected to the cathode inlet pore 51 via a second circulating pump 512. The cathode outlet pore 52 is connected to the cathode end gas storage tank 521 to store the gas generated by the cathode 1.

In preferred embodiments of the present invention, the materials used in anode 3 and cathode 1 are both porous Ag-GDC (mixture of GDC (gadolinium doped ceria, Ce_{0.8}Gd_{0.2}O_{1.9}) and silver), and the electrolyte 2 material is dense YSZ (yttrium stabilized zirconium). The cathode 1 and anode 3 materials are porous enough for gas transport, and the electrolyte 2 material is dense enough to separate the gases produced by the anode 3 and cathode 1. CO produced by carbon gasification is oxidized in the anode 3 of CA-SOEC. To avoid carbon deposits from damaging the activity of anode catalysts such as Ni, metal silver is used as the electrode material to avoid the deposition of carbon on the electrode, which affects the output performance of CA-SOEC. Cathode 1, anode 3 and electrolyte 2 materials are easily acquired, which helps to reduce the manufacturing cost of CA-SOEC. Carbonates, such as sodium carbonate, lithium carbonate, potassium carbonate or a mixture of substances, are used as catalysts to enhance water gasification reactions, changing the reaction path and reducing the reaction energy barrier, and thus ensures the stable output performance of the electrolysis with the increase anode 3 flowrate. Compared with noble metal catalysts, carbonate catalysts also have the advantages of low price and ease of acquisition. The carbon fuel is inorganic including coal, coke, active carbon, graphite, fibreboard, black carbon, and biochar. The carbon fuel from a variety of sources is conducive to reducing the manufacturing cost and is suitable for large-scale application of CA-SOEC. Furthermore, in embodiments of the present invention, the thicknesses of cathode 1, anode 3, and electrolyte 2 are 20 μm, 20 μm, and 20 μm, respectively, with the same length of 9 cm. The maximum operating voltage of CA-SOEC does not exceed 1 V. Compared with the prior art, the operating voltage of solid oxide electrolysis cell with same size is 1.4V. CA-SOEC in the present invention can realize low-voltage electrolysis of water, and even negative voltage hydrogen production. The performance of present invention is better than the existing CA-SOEC. It should be noted that the CA-SOEC size of present invention shown above does not constitute a limitation of the CA-SOEC size, and technicians can adjust the size of CA-SOEC according to actual needs.

In preferred embodiments of the present invention, the carbon-assisted solid oxide electrolysis cell operates in the temperature range of 650 to 850° C., and the CO₂ absorber is CaO. In the above temperature range, the Gibbs free energy for H₂O absorption by CaO is positive, Gibbs free energy increases with the H₂O absorption process. While the Gibbs free energy for CO₂ absorption is negative and decreases with the process. When Gibbs free energy decreases, the absorption reaction of CaO for CO₂ happens spontaneously, without H₂O absorption, which can produce more fuel gas H₂ by promoting the reversible reaction of CO and H₂O in the positive direction. Besides, the H₂ diffusion rate is faster and the electrochemical activity is higher, which is conducive to improving the output performance of CA-SOEC. Moreover, it is conducive to reducing the material and preparation costs of CA-SOEC and improving the long-term operation stability of CA-SOEC in the temperature range.

It should be noted that CaO as CO₂ absorber shown in the present invention is not limited, in the above temperature range, other substances that can absorb CO₂ and react with CO₂ having a decreased Gibbs free energy can be applicable to the present invention. Obviously, not all reactions with decreased Gibbs are suitable for embodiments of the present invention. For example, NaOH, with the melting point of 318° C., can absorb CO₂, but will melt at the operating temperature in the present invention, which is not applicable. Also, Ca(OH)₂ will dehydrate and decompose at about 600° C., which is not applicable to the embodiment of the present invention. The currently commonly used CO₂ absorber CaO, with melting point of 2572° C., has good adaptability for the embodiment of the present invention in the operating temperature.

In preferred embodiments of the present invention, the principal is: first, water is supplied into the cathode chamber 5 to generate H₂ and O²⁻, and O²⁻ is transported to anode 3 through electrolyte 2 (as shown in Formula (1)). At the same time, water is supplied into the anode chamber 4, and the water reacts with carbon fuel to form H₂ and CO (as shown in Formula (2)). H₂ and part of the CO are transported to the anode 3, oxidating with O²⁻ to generate H₂O and CO₂ (as shown in Formula (3) and Formula (4)). The other part of CO reacts with H₂O in the anode chamber 4 to generate CO₂ and H₂ by water gas shift reaction (as shown in Formula (5)). CO₂ generated by CO oxidation is transported to the anode chamber 4 for further carbon gasification reaction with carbon fuel to generate CO (as shown in Formula (6)). The CO₂ absorbers, such as CaO, absorb CO₂ generated by CO reactions in a timely (as shown in Formula (7)), and reduce the consumption of carbon fuel by CO₂ (i.e., reduce the occurrence of Formula (6)), reducing the generation of CO further. The adsorption of CO₂ simultaneously promotes the positive progress of the water gas shift reaction (reversible chemical reaction, Formula (5)), which increases the consumption of CO and raises the level of generated H₂. The present invention increase production of H₂ the and thus improve the performance of CA-SOEC. In embodiments of the present invention, the rate of water gasification reaction is increased by reducing the content of CO₂ and increasing the partial pressure of H₂O, which achieve the kinetic matching of the carbon gasification reaction-electrochemical oxidation process in CA-SOEC and improve the output performance of CA-SOEC.

| | | |
|---|---|---|
| Cathode | H₂O + 2e⁻→H₂ + O²⁻ | (1) |
| Anode | C + H₂O→H₂ + CO | (2) |
| | H₂ + O²⁻→H₂O + 2e⁻ | (3) |
| | CO + O²⁻→CO₂ + 2e⁻ | (4) |
| | CO + H₂O↔CO₂ + H₂ | (5) |
| | C + CO₂→2CO | (6) |
| | CaO + CO₂↔CaCO₃ | (7) |

In preferred embodiments of the present invention, the flowrates of water in cathode 1 and anode 3 are both 50-500 mL/min. The operating temperature in CA-SOEC is stable, and the output performance of CA-SOEC is stable, with the range of water flowrate. It should be noted that the gas flowrates of present invention are shown above, but those skilled in the art may adjust the flowrate of water according to the actual situation, such as when the CA-SOEC temperature is too high, appropriately increase the flowrate of water in cathode 1.

In preferred embodiments of the present invention, the anode chamber 4 discharges a mixture of gas comprising H₂, CO, and H₂O. The mixed gas produced by the anode chamber 4 can be used as a raw material for the synthesis of high value-added methanol and other hydrocarbon fuels, basically meeting the carbon-free system and satisfying higher energy utilization conversion efficiency.

It should be note that the embodiments shown above are better examples of the present invention and the present invention is not limited to the embodiments. Any modifications, equivalent substitutions and improvements, etc. made within the spirit and principles of the present invention shall be included in the scope of protection of the present invention.

What is claimed is:

1. A carbon-assisted solid oxide electrolysis cell, comprising: a cathode, an electrolyte, an anode and an anode chamber arranged sequentially;
wherein the cathode is supplied with water vapor as an oxidant to perform a reduction reaction;
wherein an inside of the anode chamber is provided with a carbon fuel and a CO₂ absorber, the water vapor is added into the inside of the anode chamber as an in-situ gasification agent, and the water vapor and the carbon fuel undergo a carbon gasification reaction to generate CO and H₂,
wherein O²⁻ ions produced by the cathode are transmitted to the anode through the electrolyte, and the O²⁻ ions react with the CO and the H₂ generated in the anode chamber as oxidant;
wherein a part of the CO produced by the carbon gasification reaction and the water vapor undergo a water gas shift reaction in the anode chamber to generate CO₂ and H₂, while the CO₂ absorber promotes the production of the H₂ by absorbing the CO₂ produced by the water gas shift reaction; and
wherein the CO₂ absorber is CaO, the carbon fuel is an inorganic carbon fuel, and the inorganic carbon fuel is one selected from a group consisting of coal, coke, active carbon, graphite, fibreboard, black carbon, and biochar.

2. The carbon-assisted solid oxide electrolysis cell according to claim 1, wherein the carbon-assisted solid oxide electrolysis cell operates in a temperature range of 650 to 850° C.

3. The carbon-assisted solid oxide electrolysis cell according to claim 1, wherein flowrates of the water vapor in the cathode and the anode are both 50-500 mL/min.

4. The carbon-assisted solid oxide electrolysis cell according to claim 1, wherein the carbon-assisted solid oxide electrolysis cell is a tubular electrolysis cell with a length of 9 cm, an inner diameter of 11.5 mm, and an outer diameter of 12.0 mm; and
wherein the cathode has a thickness of 20 μm;
wherein the anode has a thickness of 20 μm;
wherein the electrolyte has a thickness of 20 μm;
wherein an operating voltage of the tubular electrolysis cell is in a range of 1 V to −0.1 V.

5. The carbon-assisted solid oxide electrolysis cell according to claim 1, wherein the anode chamber discharges a mixture of gas comprising H₂, CO, and H₂O.

6. The carbon-assisted solid oxide electrolysis cell according to claim 1, wherein the inside of the anode chamber is further provided with a carbonate catalyst.

7. The carbon-assisted solid oxide electrolysis cell according to claim 1, wherein materials of the anode and the cathode are both porous Ag-GDC, and a material of the electrolyte is dense YSZ.
